(19) United States
(12) Patent Application Publication
(10) Pub. No.: US 2019/0012103 A1
(43) Pub. Date: Jan. 10, 2019

(54) VIRTUAL REMOVABLE MEMORY COMPONENT

(71) Applicant: Seagate Technology LLC, Cupertino, CA (US)

(72) Inventor: Bruno Jean MASSON, Campbell, CA (US)

(21) Appl. No.: 15/646,013

(22) Filed: Jul. 10, 2017

(51) Int. Cl. G06F 3/06

(52) U.S. Cl. CPC G06F 3/0626; G06F 3/0688; G06F 3/0685; G06F 3/0661; G06F 3/0644

(57) ABSTRACT

A data storage device includes a port for receiving a removable memory component, e.g., a secure digital card. The data storage device has a first partition and a second partition. The first partition stores data received from the removable memory component. The second partition stores pointers associated with a subset of the data stored in the first partition. The subset of data is marked as data of interest for a user based on a first set of attributes. The second partition is a virtual removable memory component and is rendered on a display as a physical removable memory component with the subset of data from the first partition that is associated with the pointers in the second partition. The subset of data stored in the first partition is fetched utilizing the pointers in the second partition and subsequently transmitted to a system external to the data storage device.

### SUMMARY

Provided herein is a data storage device. The data storage device includes a port for receiving a removable memory component, e.g., a secure digital card. The data storage device has a first partition and a second partition. The first partition stores data received from the removable memory component. The second partition stores pointers associated with a subset of the data stored in the first partition. The subset of data is marked as data of interest for a user based on a first set of attributes. The second partition is a virtual removable memory component and is rendered on a display as a physical removable memory component with the subset of data from the first partition that is associated with the pointers in the second partition. The subset of data stored in the first partition is fetched utilizing the pointers in the second partition and subsequently transmitted to a system external to the data storage device.

These and other features and advantages will be apparent from a reading of the following detailed description.

### BRIEF DESCRIPTION OF DRAWINGS

FIG. 1A shows a system with a virtual removable memory component according to one aspect of the present embodiments.

FIG. 1B shows a rendition resulting from the presence of the virtual removable memory component according to one aspect of the present embodiments.

FIG. 2A shows a system with multiple virtual removable memory components according to one aspect of the present embodiments.

FIG. 2B shows a rendition resulting from the presence of multiple virtual removable memory components according to one aspect of the present embodiments.

FIG. 3 shows one system implementation of creating virtual removable memory components according to one aspect of the present embodiments.

FIG. 4 shows a system implementation of creating virtual removable memory component with a translating module according to one aspect of the present embodiments.

FIG. 5 shows a system implementation of creating a removable memory component using a physical removable memory component according to one aspect of the present embodiments.

FIGS. 6A-6B show a flow diagram of creating a virtual removable memory component according to one aspect of the present embodiments.

### DESCRIPTION

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device or a processor. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “rendering,” “detecting,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, hard drive, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Removable memory components such as secure digital (SD) cards are commonly used to store content, e.g., pictures, videos, documents, etc. Content of removable memory components may be stored in other memory components, e.g., hard drive, solid state drive, etc. Unfortunately, the content of the removable memory components once stored in other memory components, e.g., hard drive, are structured in multiple directories and subdirectories, difficult to navigate to and access. Moreover, certain content that are tagged, e.g., tagged as a favorite, tagged based on rating, etc., lose their corresponding tags once stored in another memory component such as a hard drive. Even if the tags are maintained, the tagged content is generally not grouped together for easy access by an external system to the memory component such as a hard drive. Accordingly, a need has arisen to group tagged content together for easy presentation to a user for selection and transfer therefrom.

Accordingly, a storage device, e.g., a hard drive, a solid state drive, etc., according to some embodiments is provided. It is appreciated that throughout the application, the embodiments are described with respect to a hard drive, however, the embodiments should not be construed as limited thereto. For example, the embodiments are equally applicable to other storage devices such as a solid state drive, or a hybrid of hard drive and solid state drive, to name a few.

The hard drive includes a port for receiving a removable memory component, e.g., an SD card. The hard drive has a first partition and a second partition. The first partition is configured to store data received from the removable memory component. The second partition is configured to store pointers associated with a subset of the data stored in the first partition. The subset of data is marked as data of interest for a user based on a first set of attributes. The second partition is a virtual removable memory component and is configured to be rendered on a display as a physical removable memory component with the subset of data from the first partition that is associated with the pointers in the second partition. Responsive to a signal, the subset of data stored in the first partition is fetched utilizing the pointers in the second partition. The subset of data that is fetched is subsequently transmitted to a system external to the hard drive. The second partition groups the subset of data of together for easy presentation and access.

For example, when a removable memory component is connected to a storage device, e.g., a hard drive, the content of the removable memory component may be backed up on a first partition of the storage device. Moreover, content from the removable memory component may include tags associated therewith that may indicate whether that content is a content of interest, therefore forming a subset of the entire content from the removable memory component. For example, pictures tagged as favorites may be grouped together, pictures tagged based on location may be grouped together, pictures based on date may be grouped together, etc. Pointers to the subset of content, e.g., marked as favorites, marked based on location, marked based on date, marked based on time, marked based on rating, etc., that is stored in a first partition of the storage device may be stored in a different partition, e.g., a second partition, of the storage device. When a user, e.g., external system to the storage device, connects to the storage device, not only the storage device, e.g., external hard drive, is rendered but an icon also appears as a removable memory component, e.g., an SD card. The rendered removable memory component does not exist and it is merely a rendition representation, of the subset of the content pointed to by the pointers stored in a second partition, as a removable memory component. As such, to the user, the removable memory component is real and exists and it contains a subset of the content, e.g., favorites, ratings, location, date, time, etc. Accordingly, creating the virtual removable memory within a storage device, e.g., a hard drive, for storing a subset of the content enables the user to access the content of interest more easily and more expeditiously.

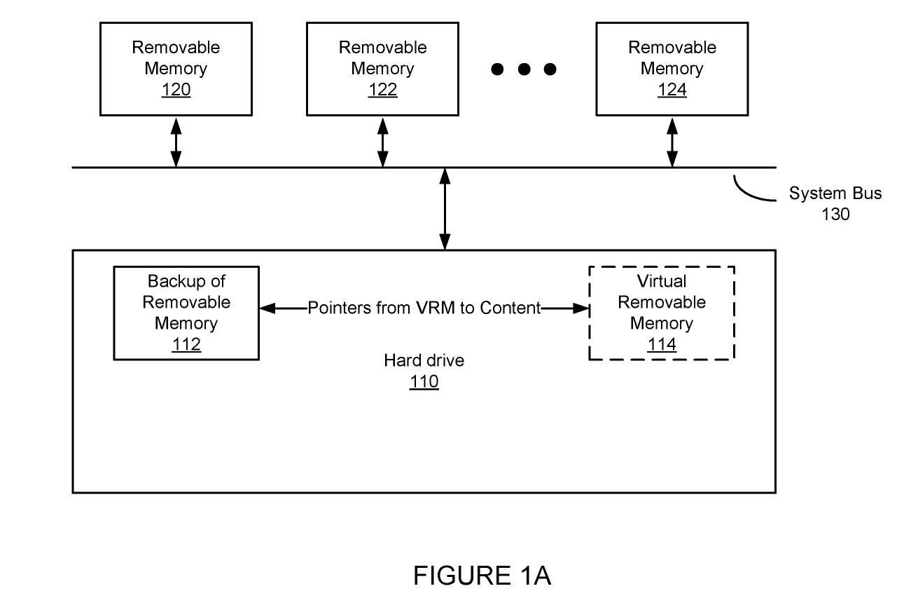

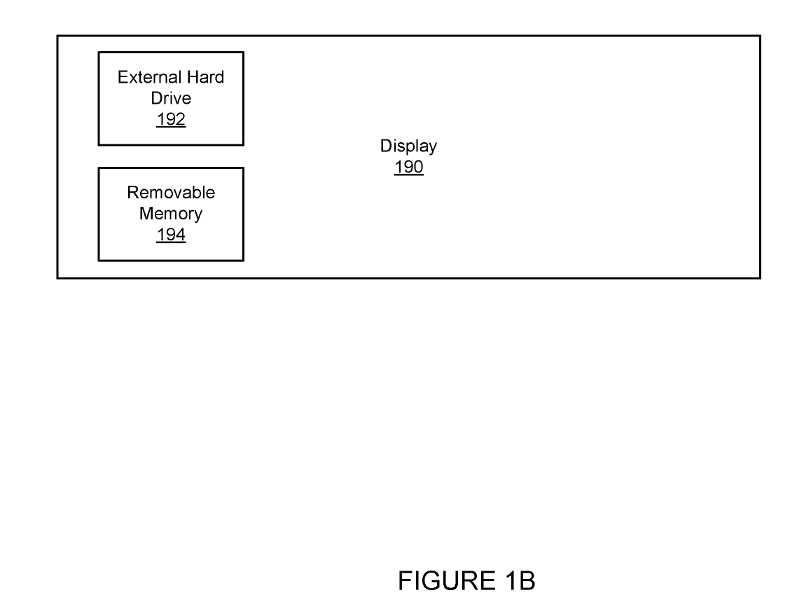

Referring now to FIG. 1A, a system with a virtual removable memory component according to one aspect of the present embodiments is shown. The system includes a hard drive 110, a system bus 130, and removable memory components 120, 122, . . . , 124. The removable memory components may be any memory card such as compact flash, smartmedia, multimediacard, secure digital (SD) card, memory stick, XQD, xD, CFast, subscriber identity module (SIM) card, universal flash storage card extension, and a USB flash drive, to name a few. For illustration purposes the embodiments are discussed with respect to an SD card but it is appreciated that the embodiments are equally applicable to other memory card formats. It is further appreciated that the removable memory components 120, and/or 122, . . . , and/or 124 may connect to the hard drive 110 simultaneously or sequentially.

The removable memory components 120, 122, . . . , 124, or any combination thereof may be electrically coupled to the hard drive 110, e.g., via a hard drive port. The hard drive 110 may detect the electrically coupling of one or more removable memory components to the hard drive 110 once one or more of the removable memory components 120, and/or 122, . . . , and /or 124 are connected to the hard drive 110. The removable memory components 120, 122, . . . , 124 may be coupled through the system bus 130 and/or a port on the hard drive 110. Once the removable memory components 120, 122, . . . , 124 are connected, the hard drive 110 may access the content thereof.

In some embodiments, the content may include photos, videos, documents, etc. It is appreciated that a subset of the content may have tags associated therewith to identify content of interest. For example, a subset of the photos may be marked as favorites, e.g., by the user. In other embodiments, a subset of the content may be marked based on certain attributes, e.g., ratings, location, date, time, etc. In some embodiments, the content of interest may be marked when the content is on the removable memory components 120, 122, . . . , 124 and prior to transferring of the content to the hard drive 110. In some embodiments, however, the content of interest may be marked after the content is transferred to the hard drive 110.

In some embodiments, the content from any of the removable memory components, e.g., removable memory component 124, may be transferred to the hard drive 110. The hard drive 110 may include a partition also referred to as backup of the removable memory 112. The backup of the removable memory 112 may store all or a subset of the content from the removable memory component 124. It is appreciated that a second partition also referred to as virtual removable memory 114 may be created, e.g., once connection between the removable memory component 124 and the hard drive 110 is detected. In some embodiments, the virtual removable memory 114 may be reserved and created even before the removable memory component is connected to the hard drive 110.

The virtual removable memory 114 may store pointers to a subset of the content stored in the back of removable memory 112. The subset of the content may be the content that is marked of interest based on, e.g., favorites, date, time, location, etc. It is appreciated that the subset of the content may be marked of interest by the user or in some embodiments automatically based on certain attributes and based on heuristics. For example, it is appreciated that the virtual removable memory 114 may be created and store the pointers to content marked based on favorites, time, location, date, etc. Accordingly, making the virtual removable memory 114 available to a user enables the user to access only the content of interest based on certain attributes such as favorites, location, date, time, etc., rather than having to access the entire backup of removable memory 112 to find the content of interest.

It is appreciated that even though the pointers are stored within the second partition 114 of the hard drive 110, the content that the pointers are pointing to in the first partition (backup of removable memory 112) is rendered on an external system to the hard drive 110 as a removable memory component, e.g., as an SD card and not as part of a hard drive. In other words, the second partition 114 of the hard drive 110 is a virtual removable memory and is rendered as an actual removable memory even though the actual removable memory component does not exist because the content thereof is stored in the hard drive 110. The subset of the content of an interest is nonetheless rendered on a display as being content on a removable memory component.

Referring now to FIG. 1B, a rendition resulting from the presence of the virtual removable memory component according to one aspect of the present embodiments is shown. A display 190 of a system external to the hard drive 110 renders an icon 192 associated with the hard drive 110. The display further renders an additional icon as a removable memory component 194 associated with the subset of the content that is of interest and is being pointed to by the pointers stored in the virtual removable memory 114. In other words, the second partition 114 of the hard drive 110 is displayed as a removable memory on display 190 even though it is not a removable memory and even though the removable memory does not exist. The removable memory 194 rendered on the display 190 is merely the content pointed to by the pointers stored in the virtual removable memory 114.

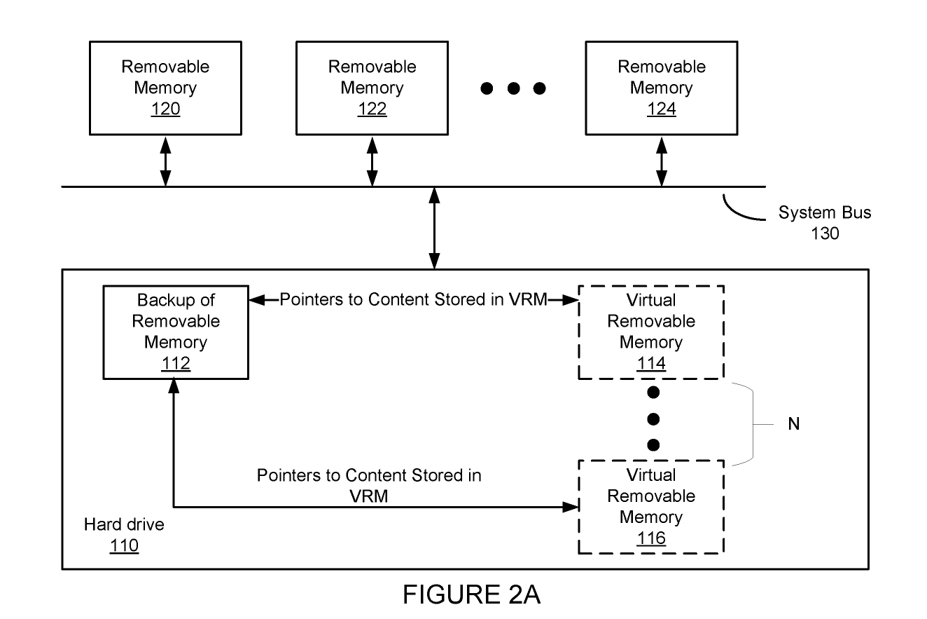

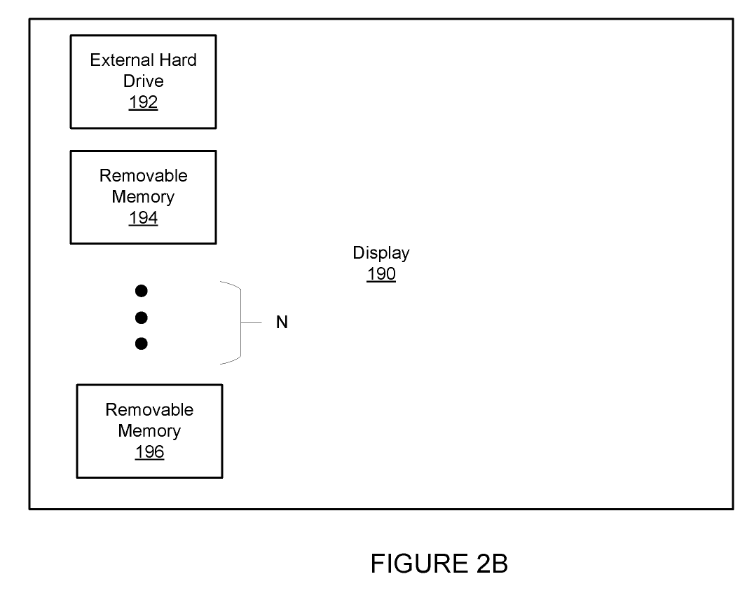

Referring now to FIG. 2A, a system with multiple virtual removable memory components according to one aspect of the present embodiments is shown. FIG. 2A is substantially similar to that of FIG. 1A. In this embodiment, more than one virtual removable memories are created in the second partition. In some embodiments, each virtual removable memory may be created in its own partition. For example, the virtual removable memory 114 may be created in the second partition of the hard drive 110 while virtual removable memory 116 may be created in the third partition of the hard drive 110. It is appreciated that there may be N additional virtual removable memories. Moreover, it is appreciated that each virtual removable memory may be associated with a separate removable memory. For example, the virtual removable memory 114 may be associated with the removable memory 120 and the virtual removable memory 116 may be associated with the removable memory 124, etc. It is further appreciated that in some embodiments, multiple virtual removable memories may be associated with the same removable memory. For example, the virtual removable memory 114 may be associated with the removable memory 120 and it may be based on certain attributes such as ratings while the virtual removable memory 116 may be associated with the removable memory 120 and it may be based on other attributes such as location and/or dates, etc.

Referring now to FIG. 2B, a rendition resulting from the presence of multiple virtual removable memory components according to one aspect of the present embodiments is shown. Similar to FIG. 1B, the virtual removable memories are rendered as removable memories 194, . . . , 196, e.g., as SD cards.

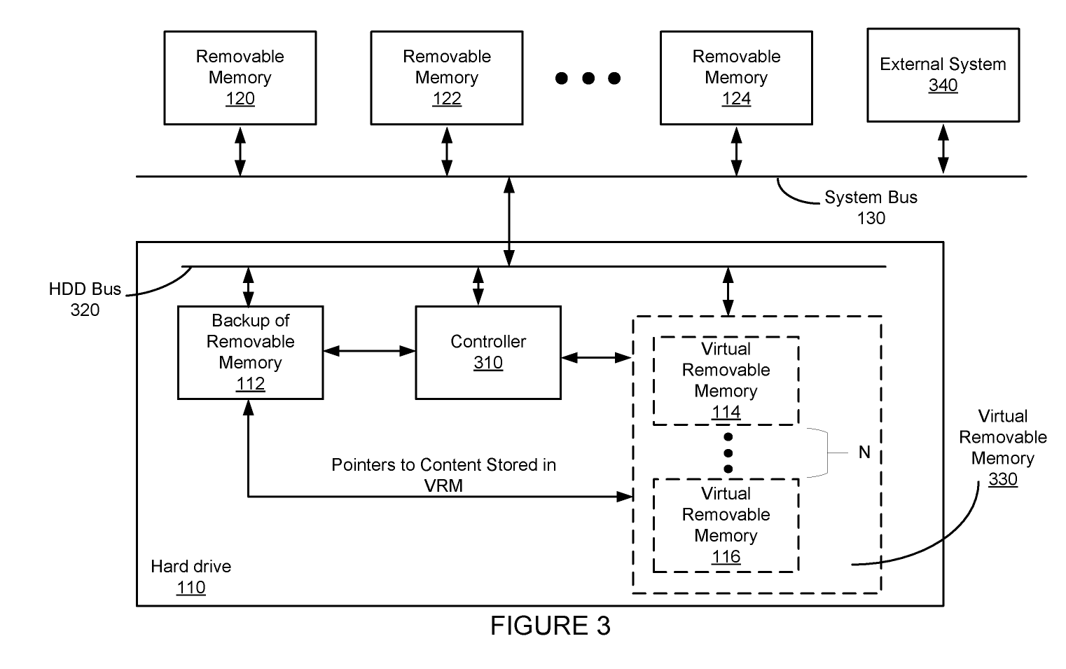

Referring now to FIG. 3, one system implementation of creating virtual removable memory components according to one aspect of the present embodiments is shown. FIG. 3 is substantially similar to that of FIG. 2A. In this embodiment, the external system 340 is connected to the hard drive via the system bus 130. It is appreciated that the hard drive 110 may further include a controller 310 and a hard drive bus 320. It is further appreciated that the virtual removable memory 330 may be created in a partition of the hard drive 110 to store pointers to a subset of the content stored in the backup of removable memory 112, as previously described. In some embodiments, the controller 310 is configured to control the data communication and the data flow between the backup removable memory 112 and the virtual removable memory 330 through the hard drive bus 320. It is appreciated that the controller 310 may further control the data communication and data flow between the hard drive 110 and the system bus 130 connecting the removable memories 120, 122, . . . , 124, and the external system 340.

In some embodiments, the controller 310 may detect that the external system 340 is connected to the hard drive 110. As a result, the controller 310 may configure the hard drive bus 320 to provide communication address and communication protocol associated with a removable memory, e.g., an SD card, as well as the communication address and communication protocol associated with the hard drive 110 to the external system 340. As such, the external system 340 receives addresses and protocols associated with removable memories as well as the hard drive 110. Therefore, the external system 340 presumes that there is more than one connection, one to the hard drive 110 and other connection(s) to one or more a removable memory, e.g., SD cards associated with the virtual removable memories 114 or . . . 116, even though no such connection is actually present. In other words, the hard drive 110 provides incorrect addresses and incorrect protocol to force the external system 340 in to detecting removable memory components even though no such removable memory components are present but are rather virtual removable memory that are stored in the hard drive 110.

In some embodiments, in response to a selection by the external system 340, e.g., user selection of the removable memory 194 icon, the content associated with the pointers stored in the virtual removable memories is transmitted to the external system 340 or the content is displayed for further user selection thereof. For example, in response to a selection, the content pointed to by the pointers stored in virtual removable memory is fetched. The fetched data may subsequently be transmitted to the external system 340. It is appreciated that the transmission of the content associated with the pointer may occur automatically. It is further appreciated that all or a subset of the content addressed by the pointers stored in the virtual removable memories may be transmitted to the external system 340. For example, a user of the external system 340 may only choose to transfer a subset of the content associated with the pointers stored in the virtual removable memory.

Accordingly, making the virtual removable memory 114 . . . 116 available to a user, e.g., external system 340, enables the user to access only the content of interest based on certain attributes such as favorites, location, date, time, etc., rather than having to access the entire backup of removable memory 112 to find the content of interest.

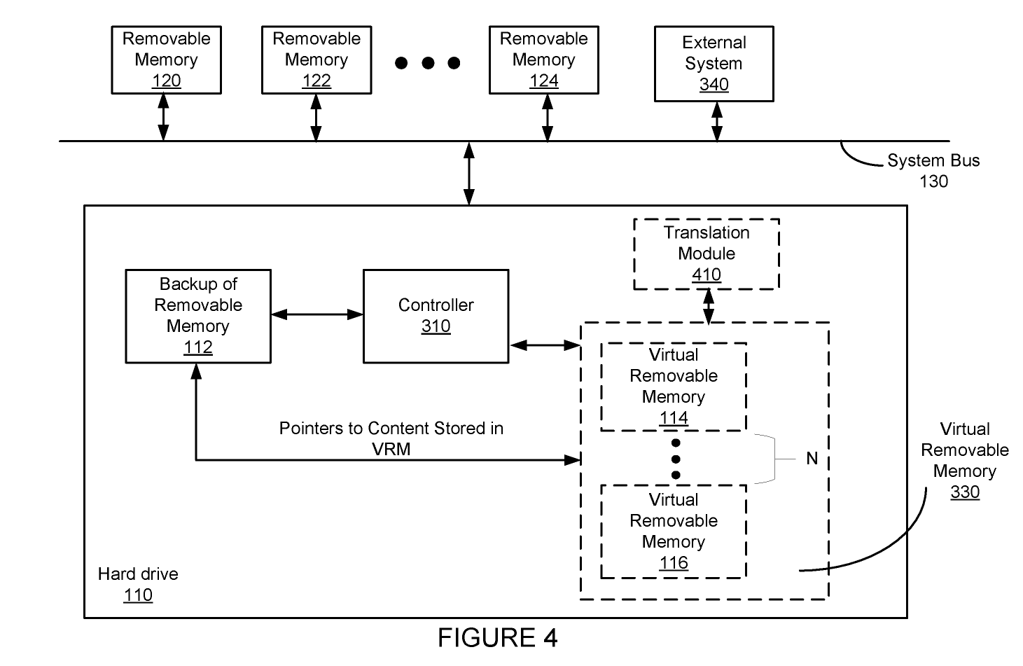

Referring now to FIG. 4, a system implementation of creating virtual removable memory component with a translating module according to one aspect of the present embodiments is shown. The embodiment of FIG. 4 is substantially similar to that of FIG. 3. In this embodiment, the hard drive 110 may include a translation module 410. The controller 310 is configured to detect the application and/or protocol associated with the external system 340. For example, the controller 310 may detect that the external system 340 is an application within the iOS or that the application is a photo or workflow application, or a Photoshop application, etc. In response to detecting the protocol, the translating module 410 may translate the tags and/or metadata associated with the subset of the content where the pointers of the virtual removable memories point to the format used by the external system 340. For example, if the subset of the content is designated as favorites in one operating environment, e.g., hard drive 110, once the subset of content is transmitted to the external system 340 it is still designated as favorites even though the operating environment of the external system 340 may be different from the one used by the hard drive 110.

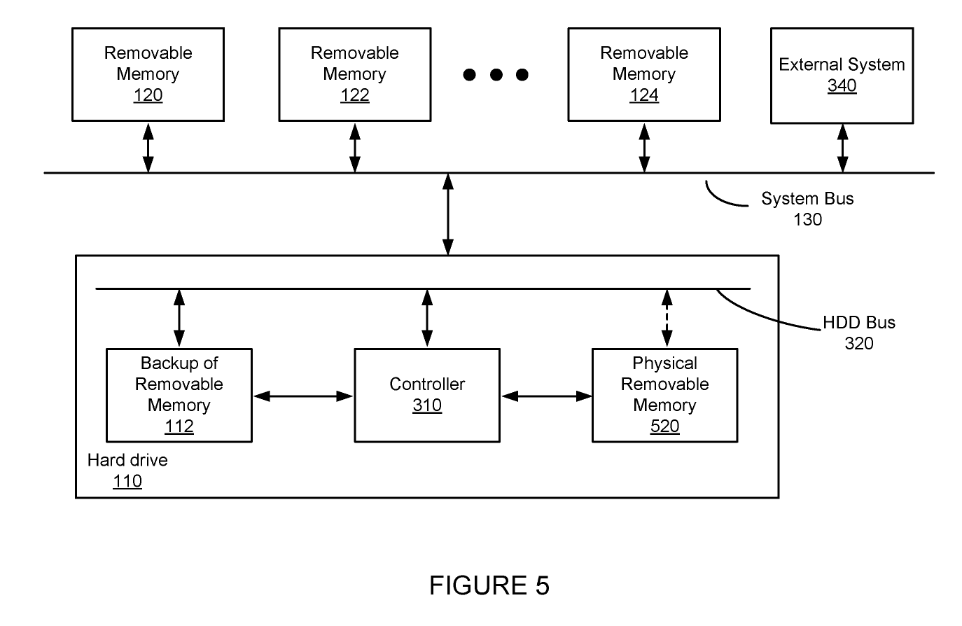

Referring now to FIG. 5, a system implementation of creating a removable memory component using a physical removable memory component according to one aspect of the present embodiments is shown. FIG. 5 is substantially similar to that of FIG. 3 described above except that instead of creating a virtual removable memory within the hard drive 110, an actual physical removable memory 520 is integrated therein. The physical removable memory 520 is substantially similar to the virtual removable memories but instead of being virtual it has physical presence and exists. The physical removable memory 520 may store the pointers similar to the virtual removable memories. The controller 310 may provide the communication address and the communication protocol of the physical removable memory 520 to the external system 340 without having to provide incorrect ones, as was done in the embodiments described in FIGS. 1A-4. As such, when the external system 340 connects to the hard drive 110, the hard drive 192 icon is rendered as well as an icon associated with the physical removable memory 520. The content associated with the pointers stored in the physical removable memory 520 is the content of interest and is a subset of the content stored in the backup of removable memory 112.

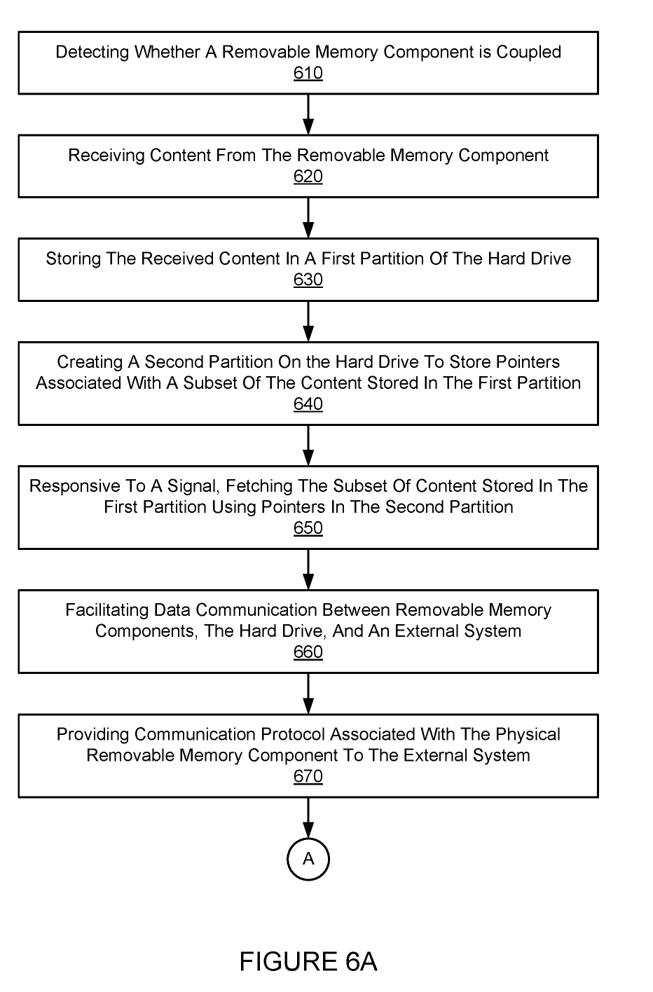

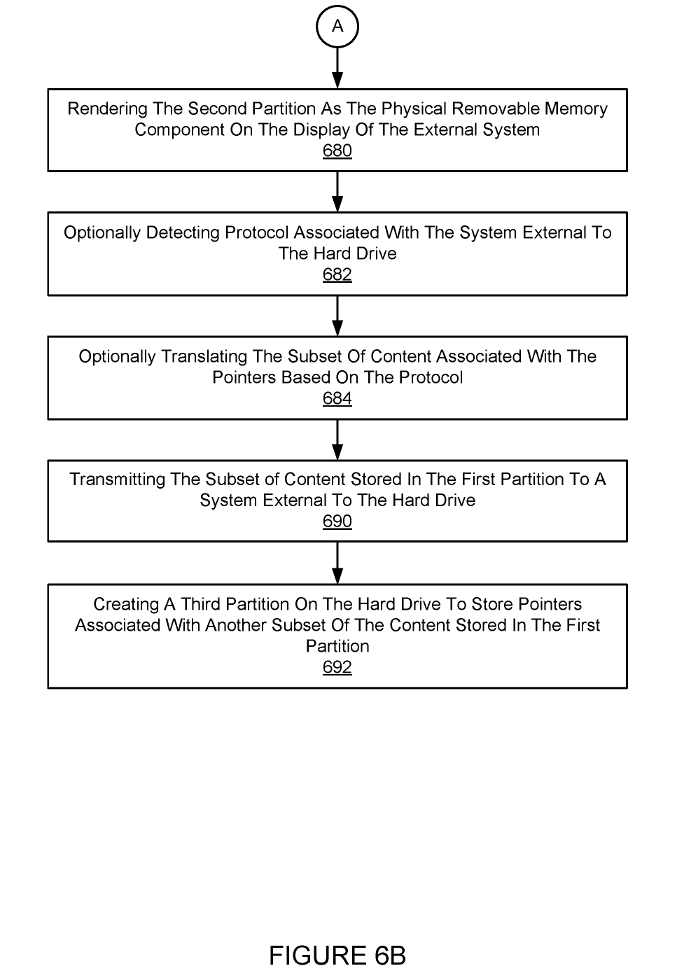

Referring now to FIGS. 6A-6B, a flow diagram of creating a virtual removable memory component according to one aspect of the present embodiments are shown. At step 610, the hard drive may detect that one or more removable memories, e.g., SD cards, is coupled to the hard drive. At step 620, the hard drive may receive the content from the removable memory. At step 630, the received content may be stored in the first partition of the hard drive, e.g., in the back up of removable memory 112. At step 640, a second partition within the hard drive may be created. It is appreciated that the second partition, e.g., virtual removable memory, may be created in response to detecting that the removable memory component is connected for the first time. It is further appreciated that the second partition, e.g., virtual removable memory, may be created prior to any connection between the hard drive and one or more removable memory component. The virtual removable memory may store pointers to a subset of the content stored in the backup removable memory component 112.

At step 650, in response to a signal, e.g., a user indication, connection of the external system to the hard drive, etc., the subset of the content stored in the backup of removable memory pointed to by the pointers stored in the virtual removable memory is fetched. At step 660, data communication between the removable memory components, the hard drive, and the external system is facilitated. At step 670, the communication protocol and the address for the virtual removable memory as well as the communication protocol and the address for the backup of removable memory is provided to the external system. Thus, at step 680, the external system may render more than one icon, one for the hard drive and one or more associated with virtual removable memories.

Optionally at step 682, the protocol associated with the external system to the hard drive is detected. Accordingly, optionally at step 684, the subset of content associated with the pointers may be translated to the detected protocol. At step 690, the subset of the content stored in the backup of removable memory pointed to by the pointers stored in the virtual removable memory (whether translated or not) may be transmitted to the external system. It is appreciated that at step 692, a third partition, e.g., another virtual removable memory, may be created in the hard drive to store pointers associated with another subset of content stored in the backup removable memory.

Accordingly, the virtual removable memory is made available to a user, e.g., external system 340. Thus, the user is now enabled to access only the content of interest based on certain attributes such as favorites, location, date, time, etc., rather than having to access the entire backup of removable memory 112 to find the content of interest.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A data storage device comprising:
a first partition configured to store data received from a removable memory component; and
a second partition configured to store pointers associated with a subset of the data stored in the first partition, wherein the subset of data is marked as data of interest for a user based on a first set of attributes, wherein the second partition is a virtual removable memory component, and wherein the second partition is configured to be rendered on a display as a physical removable memory component with the subset of data from the first partition that is associated with the pointers in the second partition, and wherein responsive to a signal the subset of data stored in the first partition is fetched utilizing the pointers in the second partition and wherein responsive to the signal the subset of data that is fetched is transmitted to a system external to the data storage device.

2. The data storage device of claim 1, wherein the subset of data is marked as data of interest for the user based on a user indication.

3. The data storage device of claim 1, wherein the removable memory component is a memory card selected from a group consisting of compact flash, smartmedia, multimediacard, secure digital, memory stick, XQD, xD, universal flash storage card extension, and a USB flash drive, and wherein the virtual removable memory component is a virtual removable memory card selected from a group consisting of compact flash, smartmedia, multimediacard, secure digital, memory stick, XQD, xD, universal flash storage card extension, and a USB flash drive.

4. The data storage device of claim 1, wherein the first set of attributes is selected from a group consisting of date, location, time, and ratings.

5. The data storage device of claim 1 further comprising:
a third partition configured to store pointers associated with another subset of the data stored in the first partition, wherein the another subset of data is marked as data of interest for the user based on a second set of attributes, wherein the third partition is another virtual removable memory component, and wherein the third partition is configured to be rendered on a display as another physical removable memory component, and wherein responsive to a signal the another subset of data stored in the first partition is fetched utilizing the pointers in the third partition and wherein responsive to the signal the another subset of data that is fetched is transmitted to a system external to the data storage device.

6. The data storage device of claim 1, wherein the data storage device is a hard drive and wherein the data storage device further comprises:
a hard drive bus configured to facilitate data communication between removable memory components external to the hard drive, an external system external to the hard drive, and the hard drive; and
a processor configured to control the hard drive bus, wherein the processor is further configured to create the second partition in response to detecting a coupling of a removable memory component to the hard drive for a first time, and wherein the processor is further configured to provide communication protocol associated with the physical removable memory component to the hard drive bus to be provided to the external system instead of communication protocol associated with the hard drive, wherein providing communication protocol associated with the physical removable memory renders the second partition as the physical removable memory component on the display.

7. The data storage device of claim 1 further comprising a translation module configured to detect protocol associated with the system external to the data storage device and wherein the translation module is further configured to translate the subset of data associated with the pointer based on the protocol before transmitting the subset of data to the system external to the data storage device.

8. A method comprising:
detecting that a removable memory component is electrically coupled to a data storage device;
receiving content from the removable memory component;
storing the received content in a first partition of the data storage device; and
creating a second partition on the data storage device to store pointers associated with a subset of the content stored in the first partition, wherein the subset of content is marked as data of interest for a user based on a first set of attributes, wherein the second partition is a virtual removable memory component, and wherein the second partition is configured to be rendered on a display as a physical removable memory component with the subset of content from the first partition that is associated with the pointers in the second partition.

9. The method of claim 8 further comprising:
responsive to a signal, fetching the subset of content stored in the first partition utilizing the pointers in the second partition; and
subsequent to the fetching, transmitting the subset of content stored in the first partition to a system external to the data storage device.

10. The method of claim 8 further comprising:
creating a third partition on the data storage device to store pointers associated with another subset of the content stored in the first partition, wherein the another subset of content is marked as data of interest for a user based on a second set of attributes, wherein the third partition is another virtual removable memory component, and wherein the third partition is configured to be rendered on the display as another physical removable memory component with the another subset of content from the first partition that is associated with the pointers in the third partition.

11. The method of claim 8, wherein the removable memory component is a memory card selected from a group consisting of compact flash, smartmedia, multimediacard, secure digital, memory stick, XQD, xD, universal flash storage card extension, and a USB flash drive, and wherein the virtual removable memory component is a virtual removable memory card selected from a group consisting of compact flash, smartmedia, multimediacard, secure digital, memory stick, XQD, xD, universal flash storage card extension, and a USB flash drive.

12. The method of claim 8, wherein the first set of attributes is selected from a group consisting of date, location, time, and ratings.

13. The method of claim 8 further comprising:
facilitating data communication between removable memory components external to the data storage device, an external system external to the data storage device, and the data storage device; and
creating the second partition in response to detecting a coupling of a removable memory component to the data storage device for a first time;
providing communication protocol associated with the physical removable memory component to the external system instead of communication protocol associated with the data storage device; and
rendering the second partition as the physical removable memory component on the display responsive to the providing communication protocol associated with the physical removable memory component to the external system.

14. The method of claim 8 further comprising:
detecting protocol associated with the system external to the data storage device; and
translating the subset of content associated with the pointer based on the protocol.

15. A system comprising:
a data storage device comprising
a port configured to receive a removable memory component;
a first partition configured to store data received from the removable memory component; and
a second partition configured to store pointers associated with a subset of the data stored in the first partition, wherein the subset of data is marked as data of interest for a user based on a first set of attributes, wherein the second partition is a virtual removable memory component; and
an external system to the data storage device comprising a display configured to render the second partition as a physical removable memory component with the subset of data from the first partition that is associated with the pointers in the second partition, and wherein responsive to a signal the subset of data stored in the first partition is fetched utilizing the pointers in the second partition and transmitted to the external system.

16. The system of claim 15, wherein the subset of data is marked as data of interest for the user based on a user indication.

17. The system of claim 15, wherein the removable memory component is a memory card selected from a group consisting of compact flash, smartmedia, multimediacard, secure digital, memory stick, XQD, xD, universal flash storage card extension, and a USB flash drive, and wherein the virtual removable memory component is a virtual removable memory card selected from a group consisting of compact flash, smartmedia, multimediacard, secure digital, memory stick, XQD, xD, universal flash storage card extension, and a USB flash drive.

18. The system of claim 15, wherein the first set of attributes is selected from a group consisting of date, location, time, and ratings.

19. The system of claim 15, wherein the data storage device further comprises:
a third partition configured to store pointers associated with another subset of the data stored in the first partition, wherein the another subset of data is marked as data of interest for the user based on a second set of attributes, wherein the third partition is another virtual removable memory component, and wherein the third partition is configured to be rendered on the display as another physical removable memory component, and wherein responsive to another signal the another subset of data stored in the first partition is fetched utilizing the pointers in the third partition and wherein responsive to the another signal the another subset of data that is fetched is transmitted to the external system.

20. The system of claim 15, wherein the data storage device is a hard drive, and wherein the hard drive comprises:
a hard drive bus configured to facilitate data communication between the removable memory component, the external system, and the hard drive; and
a processor configured to control the hard drive bus, wherein the processor is further configured to create the second partition in response to detecting a coupling of the removable memory component to the hard drive for a first time, and wherein the processor is further configured to provide communication protocol associated with the physical removable memory component to the hard drive bus to be provided to the external system instead of communication protocol associated with the hard drive, wherein providing communication protocol associated with the physical removable memory renders the second partition as the physical removable memory component on the display.

21. The system of claim 15, wherein the data storage device further comprises a translation module configured to detect protocol associated with the system external to the data storage device and wherein the translation module is further configured to translate the subset of data associated with the pointer based on the protocol before transmitting the subset of data to the system external to the data storage device.
